(19) United States
(12) Patent Application Publication
(10) Pub. No.: US 2024/0052109 A1
(43) Pub. Date: Feb. 15, 2024

(54) POLYSILOXANE VINYLIC MONOMERS AND USES THEREOF

(71) Applicant: Alcon Inc., Fribourg (CH)

(72) Inventors: Frank Chang, Cumming, GA (US); Adam K. Sniady, Lilburn, GA (US)

(21) Appl. No.: 18/359,035

(22) Filed: Jul. 26, 2023

Related U.S. Application Data
(60) Provisional application No. 63/369,562, filed on Jul. 27, 2022.

(51) Int. Cl. C08G 77/26; G02B 1/04

(52) U.S. Cl. CPC C08G 77/26; G02B 1/043; C08G 2210/00

(57) ABSTRACT

The invention provides a polysiloxane vinylic monomer which comprises (1) a polysiloxane polymer chain comprising at least 5 dimethylsiloxane units in a consecutive sequence, (2) one sole terminal (meth)acryloyl or styrenyl group, and (3) a quaternary ammonium moiety. Due to presence of the quaternary ammonium moiety, a polysiloxane vinylic monomer of the invention is relatively compatible with hydrophilic vinylic monomers used in a silicone hydrogel lens formulation for making silicone hydrogel contact lenses. The present invention is also related to a silicone hydrogel contact lens, which comprises repeating units of a polysiloxane vinylic monomer of the invention.

This application claims the benefits under 35 USC § 119 (e) of U.S. provisional application No. 63/369,562, filed on 27 Jul. 2022, incorporated by reference in its entirety.

The present invention is related to a polysiloxane vinylic monomer that comprises a quaternary ammonium moiety and is suitable for making silicone hydrogel contact lenses. In addition, the present invention is related to silicone hydrogel contact lenses made from a lens formulation comprising such a polysiloxane vinylic monomer.

### BACKGROUND

In recent years, silicone hydrogel contact lenses become more and more popular because of their high oxygen permeability and comfort. “Soft” contact lenses can conform closely to the shape of the eye, so oxygen cannot easily circumvent the lens. Soft contact lenses must allow oxygen from the surrounding air (i.e., oxygen) to reach the cornea because the cornea does not receive oxygen from the blood supply like other tissue. If sufficient oxygen does not reach the cornea, corneal swelling occurs. Extended periods of oxygen deprivation cause the undesirable growth of blood vessels in the cornea. By having high oxygen permeability, a silicone hydrogel contact lens allows sufficient oxygen to permeate through the lens to the cornea and to have minimal adverse effects on corneal health.

Typically, silicone hydrogel contact lenses are produced according to a cast molding technique involving use of disposable or reusable molds and a silicone hydrogel lens formulation (i.e., a mixture of vinylic monomers and/or vinylic macromers). A silicone hydrogel lens formulation (a polymerizable composition) often comprises a polysiloxane (e.g., polydimethylsiloxane) vinylic monomer which can provide high oxygen permeability to resultant contact lenses. However, such a polysiloxane vinylic monomer often has a limited compatibility with other hydrophilic polymerizable components in a lens formulation. It would be difficult to obtain homogeneous lens formulations (i.e., clear lens formulations) from use of such a polysiloxane vinylic monomer. It would be even more difficult to obtain a homogeneous, solventless lens formulation from use of such a polysiloxane vinylic monomer. Phase separation may even happen after prolonged storage in refrigerated conditions.

Therefore, there is a need for new hydrophilized polysiloxane vinylic monomers which are compatible with hydrophilic polymerizable components and are suitable for preparing lens formulations for making silicone hydrogel contact lenses.

### SUMMARY OF THE INVENTION

The present invention, in one aspect, provides a polysiloxane vinylic monomer. The polysiloxane vinylic monomer of the invention comprises: (1) a polysiloxane polymer chain comprising at least 5 dimethylsiloxane units; (2) one sole terminal ethylenically unsaturated group which is (meth)acryloyl or styrenyl group; and (3) a quaternary ammonium moiety.

In another aspect, the invention provides a silicone hydrogel contact lens comprising a crosslinked polymeric material comprising: units of a polysiloxane vinylic monomer of the invention (described above).

### DETAILED DESCRIPTION OF EMBODIMENTS OF THE INVENTION

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

“About” as used herein means that a number referred to as “about” comprises the recited number plus or minus 1-10% of that recited number.

“Contact Lens” refers to a structure that can be placed on or within a wearer's eye. A contact lens can correct, improve, or alter a user's eyesight, but that need not be the case.

A “silicone hydrogel contact lens” or “SiHy contact lens” interchangeably refers to a contact lens comprising a silicone hydrogel material as bulk material.

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” interchangeably refers to a silicone-containing hydrogel comprising repeating units of at least one silicone-containing monomer and/or silicone-containing vinylic crosslinker and repeating units of at least hydrophilic vinylic monomer. It is typically formed by copolymerization of a polymerizable composition comprising at least one silicone-containing monomer and/or silicone-containing vinylic crosslinker and at least one hydrophilic vinylic monomer.

As used in this application, the term “non-silicone hydrogel” refers to a hydrogel that is theoretically free of silicon.

“Hydrophilic,” as used herein, describes a material or portion thereof that will more readily associate with water than with lipids.

A “vinylic monomer” refers to a compound that has one sole ethylenically unsaturated group and is soluble in a solvent.

The term “soluble”, in reference to a compound or material in a solvent, means that the compound or material can be dissolved in the solvent to give a solution with a concentration of at least about 0.5% by weight at room temperature (i.e., a temperature of about 21° C. to about 27° C.).

The term “insoluble”, in reference to a compound or material in a solvent, means that the compound or material can be dissolved in the solvent to give a solution with a concentration of less than 0.01% by weight at room temperature (as defined above).

The term “ethylenically unsaturated group” is employed herein in a broad sense and is intended to encompass any groups containing at least one >C═C< group. Exemplary ethylenically unsaturated groups include without limitation

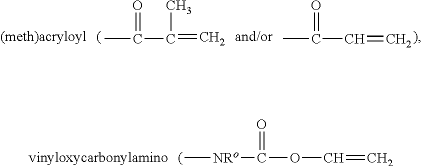

in which R^{o} is H or C₁-C₄ alkyl),

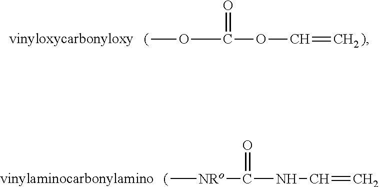

in which R^{o} is H or C₁-C₄ alkyl),

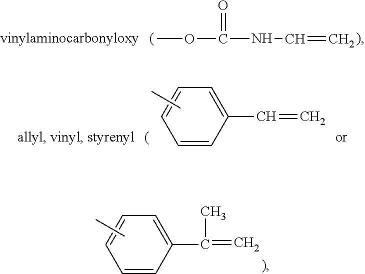

or other C═C containing groups.

The term “terminal ethylenically unsaturated group” refers to one ethyleneically unsaturated group at one of the two ends of the main chain (or backbone) of an organic compound as known to a person skilled in the art.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV irradiation, ionizing radiation (e.g., gamma ray or X-ray irradiation), microwave irradiation, and the like. Thermal curing or actinic curing methods are well-known to a person skilled in the art.

An “acrylic monomer” refers to a vinylic monomer having one sole (meth)acryloyl group. Examples of acrylic monomers includes (meth)acryloxy [or(meth)acryloyloxy] monomers and (meth)acrylamido monomers.

An “(meth)acryloxy monomer” or “(meth)acryloyloxy monomer” refers to a vinylic monomer having one sole group of

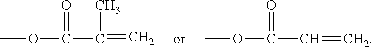

An “(meth)acrylamido monomer” refers to a vinylic monomer having one sole group of

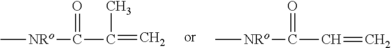

in which R^{o} is H or C₁-C₄ alkyl.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

The term “ene group” refers to a monovalent radical of CH₂=CH— or CH₂=CCH₃— that is not covalently attached to an oxygen or nitrogen atom or a carbonyl group.

An “ene monomer” refers to a vinylic monomer having one sole ene group.

An “styrenyl monomer” refers to a vinylic monomer having one sole styrenyl group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

A “blending vinylic monomer” refers to a vinylic monomer capable of dissolving both hydrophilic and hydrophobic components of a polymerizable composition to form a solution.

A siloxane, which often also described as a silicone, refers to a molecule having at least one moiety of —Si—O—Si— where each Si atom carries two organic groups as substituents.

A “silicone-containing vinylic monomer or crosslinker” or a “siloxane-containing vinylic monomer or crosslinker” interchangeably refers to a vinylic monomer or crosslinker having at least one moiety of —Si—O—Si— where each Si atom carries at least two substituents (organic groups).

A “polysiloxane segment” or “polydiorganosiloxane segment” interchangeably refers to a polymer chain segment (i.e., a divalent radical) of

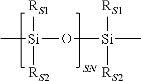

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl; and a photochromic organic radical having a photochromic group.

A “polydiorganosiloxane vinylic monomer” or “polysiloxane vinylic monomer” interchangeably refers to a compound comprising at least one polysiloxane segment and one sole ethylenically-unsaturated groups.

A “polydiorganosiloxane vinylic crosslinker” or “polysiloxane vinylic crosslinker” interchangeably refers to a compound comprising at least one polysiloxane segment and at least two ethylenically-unsaturated groups.

A “linear polysiloxane vinylic crosslinker” refers to a compound comprising a main chain which includes at least one polysiloxane segment and is terminated with one ethylenically-unsaturated group at each of the two ends of the main chain.

A “chain-extended polydiorganosiloxane vinylic crosslinker” or “chain-extended polysiloxane vinylic crosslinker” interchangeably refers to a compound comprising at least two ethylenically-unsaturated groups and at least two polysiloxane segments each pair of which are linked by one divalent radical.

A “macromer” or “prepolymer” refers to a compound or polymer that contains ethylenically unsaturated groups and has an average molecular weight greater than 700 Daltons.

A “polymer” means a material formed by polymerizing/crosslinking one or more vinylic monomers, macromers and/or prepolymers.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatochraphy) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy, etc.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates radical crosslinking/polymerizing reaction by the use of heat energy.

“Post-curing surface treatment”, in reference to a silicone hydrogel bulk material or a SiHy contact lens, means a surface treatment process that is performed after the silicone hydrogel bulk material or the SiHy contact lens is formed by curing (i.e., thermally or actinically polymerizing) a SiHy lens formulation.

“Surface modification” or “surface treatment”, as used herein, means that an article has been treated in a surface treatment process (or a surface modification process) prior to or posterior to the formation of the article, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, a surface treatment by energy (e.g., a plasma, a static electrical charge, irradiation, or other energy source), chemical treatments, the grafting of hydrophilic vinylic monomers or macromers onto the surface of an article, mold-transfer coating process disclosed in U.S. Pat. No. 6,719,929 (herein incorporated by reference in its entirety), the incorporation of wetting agents into a lens formulation for making contact lenses proposed in U.S. Pat. Nos. 6,367,929 and 6,822,016 (herein incorporated by references in their entireties), reinforced mold-transfer coating disclosed in U.S. Pat. No. 7,858,000 (herein incorporated by reference in its entirety), and a hydrophilic coating composed of covalent attachment or physical deposition of one or more layers of one or more hydrophilic polymer onto the surface of a contact lens disclosed in U.S. Pat. Nos. 8,147,897 and 8,409,599 and US Patent Application Publication Nos. 2011/0134387, 2012/0026457 and 2013/0118127 (herein incorporated by references in their entireties).

A “hydrophilic surface” in reference to a silicone hydrogel material or a contact lens means that the silicone hydrogel material or the contact lens has a surface hydrophilicity characterized by having an averaged water contact angle of about 90 degrees or less, preferably about 80 degrees or less, more preferably about 70 degrees or less, more preferably about 60 degrees or less.

An “average contact angle” refers to a water contact angle (advancing angle measured by Sessile Drop), which is obtained by averaging measurements of at least 3 individual contact lenses.

The term “silicone hydrogel lens formulation” or “SiHy lens formulation” interchangeably refers to a polymerizable composition that comprises all necessary polymerizable components for producing a silicone hydrogel (SiHy) contact lens or a SiHy lens bulk material as well known to a person skilled in the art.

As used herein, the term “multiple” refers to three or more.

A “UV-absorbing vinylic monomer” refers to a compound comprising an ethylenically-unsaturated group and a UV-absorbing moiety which can absorb or screen out UV radiation in the range from 200 nm to 400 nm as understood by a person skilled in the art.

A “HEVL-absorbing vinylic monomer” refers to a compound comprising an ethylenically-unsaturated group and a HEVL-absorbing moiety which can absorb or screen out HEVL (high-energy-violet-light) radiation in the range from 380 nm to 440 nm as understood by a person skilled in the art.

As used in this application, the term “phosphorylcholine” refers to a zwitterionic group of

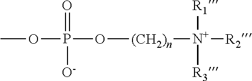

in which n is an integer of 1 to 5 and R₁′″, R₂′″ and R₃′″ independently of each other are C₁-C₈ alkyl or C₁-C₈ hydroxyalkyl.

The term “fluid” as used herein indicates that a material can flow like a liquid.

As used in this application, the term “clear” in reference to a polymerizable composition means that the polymerizable composition is a transparent solution or liquid mixture (i.e., having a light transmissibility of 85% or greater, preferably 90% or greater in the range between 400 to 700 nm).

The intrinsic “oxygen permeability”, Dkᵢ, of a material is the rate at which oxygen will pass through a material. As used in this application, the term “oxygen permeability (Dk)” in reference to a hydrogel (silicone or non-silicone) or a contact lens means a corrected oxygen permeability (Dk_{c}) which is measured at about 34-35° C. and corrected for the surface resistance to oxygen flux caused by the boundary layer effect according to the procedures described in ISO 18369-4. Oxygen permeability is conventionally expressed in units of barrers, where “barrer” is defined as [(cm³ oxygen)(cm)/(cm²)(sec)(mm Hg)]×10⁻⁹.

The “oxygen transmissibility”, Dk/t, of a lens or material is the rate at which oxygen will pass through a specific lens or material with an average thickness of t [in units of mm] over the area being measured. Oxygen transmissibility is conventionally expressed in units of barrers/mm, where “barrers/mm” is defined as [(cm³ oxygen)/(cm²)(sec)(mm Hg)]×10⁻⁹.

The term “modulus” or “elastic modulus” in reference to a contact lens or a material means the tensile modulus or Young's modulus which is a measure of the stiffness of a contact lens or a material in tension. A person skilled in the art knows well how to determine the elastic modulus of a SiHy material or a contact lens. For example, all commercial contact lenses have reported values of elastic modulus.

A “coating” in reference to a contact lens means that the contact lens has, on its surfaces, a thin layer of a material that is different from the bulk material of the contact lens and obtained by subjecting the contact lens to a surface treatment.

In general, the invention is directed to a class of polysiloxane vinylic monomers which each comprise: (1) a polydiorganosiloxane polymer chain comprising at least 5 dimethylsiloxane units in a consecutive sequence; (2) one sole terminal ethylenically unsaturated group; and (3) a quaternary ammonium moiety.

There are some potential unique features associated with use of polysiloxane vinylic monoms of the invention in making SiHy contact lenses.

First, a polysiloxane vinylic monomer of the invention is more compatible with other hydrophilic polymerizable components (e.g., hydrophilic vinylic monomer, hydrophilic crosslinking agent, and/or hydrophilic prepolymer), because of the presence of a quarternary ammonium salt moiety. Because of its bulky hydrophobic alkyl substituents and different counter ions, a quaternary ammonium salt can go back and forth between hydrophilic and hydrophobic phases. As such, quaternary ammonium salt is frequently used as a phase transfer catalyst. Therefore, a polysiloxane vinylic monomer of the invention is suitable for preparing various solvent-containing or solventless SiHy lens formulations which can contain a large amount of hydrophilic polymerizable component and are still clear at room temperature or even at a low storage temperature of from about 0° C. to about 4° C. Such a lens formulation can be advantageously prepared in advance in the production.

Second, because a polysiloxane vinylic monomer of the invention has at least 5 dimethylsiloxane units in a consecutive sequence, it may be used to efficiently provide relatively-high oxygen permeability per siloxane unit without adversely affecting its compatibility with other hydrophilic polymerizable components.

The present invention, in one aspect, provides a polysiloxane vinylic monomer. The polysiloxane vinylic monomker of the invention comprises: (1) a polysiloxane polymer chain comprising at least 5 dimethylsiloxane units in a consecutive sequence; (2) one sole terminal ethylenically unsaturated group; and (3) a quaternary ammonium moiety.

In accordance with the invention, a polysiloxane vinylic monomer of the invention is preferably defined by formula (1)

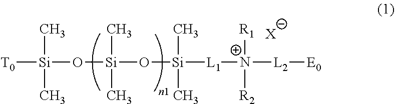

in which:
T₀ is a linear or branched C₁-C₆ alkyl which is optionally substituted with a hydroxyl or C₁-C₃ alkoxy group;
X^{⊖} is a counter anion (e.g., Cl⁻, Br⁻, I⁻, CH₃COO⁻, or the likes);
R₁ and R₂ independent of each other are a C₁-C₄ alkyl
E₀ is a monovalent radical of

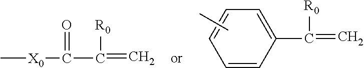

R₀ is hydrogen or methyl;
a₀ is zero or 1;
X₀ is O or NR_{N1};
R_{N1} is hydrogen or a C₁-C₆ alkyl;
n1 is an integer of from 4 to 50
L₁ is a divalent radical of

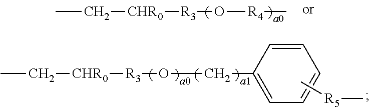

a₀ and a₁ independent of each other are zero or 1;
R₃ and R₅ independent of each other are a direct bond or a linear or branched C₁-C₃ alkylene divalent radical which is optionally substituted with C₁-C₄ alkoxy group or hydroxyl group;
R₄ is a linear or branched C₁-C₆ alkylene divalent radical which is optionally substituted with C₁-C₄ alkoxy group or hydroxyl group;
R₅ is a direct bond, a linear or branched C₁-C₃ alkylene divalent radical which is optionally substituted with C₁-C₄ alkoxy group or hydroxyl group, or a divalent radical of

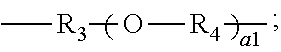

L₂ is either a linear or branched C₁-C₆ alkylene divalent radical which is optionally substituted with C₁-C₃ alkoxy or hydroxyl group or a divalent radical of

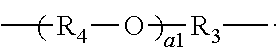

In a preferred embodiment, in formula (1) E₀ is a monovalent radical of

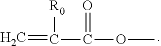

In another preferred embodiment, in formula (1) E₀ is a monovalent radical of

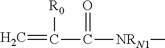

in which R_{N1} is hydrogen or a C₁-C₆ alkyl.

In another preferred embodiment, in formula (1) E₀ is a monovalent radical of

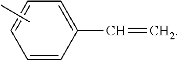

In another preferred embodiment, in formula (1) n1 is from 4 to 40, preferably from 4 to 30, more preferably from 4 to 20, even more preferably from 4 to 15.

A polysiloxane vinylic monomer of formula (1) can be prepared from a mono-hydride-terminated polydimethylsiloxane in a two-step process.

In the first step, a mono-hydride-terminated polydimethylsiloxane can be reacted with an ene monomer having one sole halogen atom (Cl or Br) in a platinum-catalyzed hydrosilylation reaction as known to a person skilled in the art, to obtain a polysiloxane having one sole terminal group including one sole halogen atom; and then in the second step, the polysiloxane having one sole terminal group including one sole halogen atom is reacted with an acrylic or styrenyl monomer having one sole tertiary amino group (i.e., a tertiary-amino-containing acrylic or styrenyl monomer of E₀-L₂-NR₁R₂) in a halogen-amine coupling reaction under conditions known to a person skilled in the art, to obtain a polysiloxane vinylic monomer of formula (1), as illustrated in Scheme I.

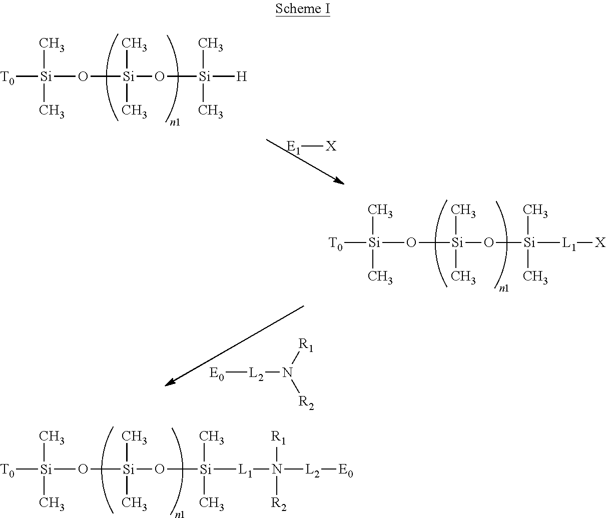

in which: T₀, E₀, L₁, L₂, R₁, and R₂ are defined as above in formula (1); X is Cl or Br; E₁ is a monovalent radical of of

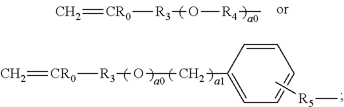

R₀, R₃, R₄, R₅, a₀, and a₁ are defined as above in formula (1).

Mono-hydride-terminated polydimethylsiloxanes can be obtained from commercial sources or prepared according to any known methods known to a person skilled in the art.

Any ene monomers can be used in the prepation, so long as they each have one sole halogen atom (Cl or Br). Examples of preferred ene monomers each having one sole halogen atom (Cl or Br) include without limitation: vinyl chloride, 2-chloro-1-propene, vinyl bromide, allyl chloride, allyl bromide, 2-chloro-1-propene, 2-bromo-1-propene, 4-chloro-1-butene, 4-bromo-1-butene, 3-chloro-1-butene, 3-bromo-1-butene, 3-chloro-2-methyl-1-propene, 3-bromo-2-methyl-1-propene, 5-chloro-1-pentene, 5-bromo-1-pentene, 4-chloro-1-pentene, 4-bromo-1-pentene, 3-chloro-1-pentene, 3-bromo-1-pentene, 4-chloro-2-methyl-1-butene, 4-bromo-2-methyl-1-butene, 3-chloro-2-methyl-1-butene, 3-bromo-2-methyl-1-butene, 6-chloro-1-hexene, 6-bromo-1-hexene, 5-chloro-1-hexene, 5-bromo-1-hexene, 4-chloro-1-hexene, 4-bromo-1-hexene, 3-chloro-1-hexene, 3-bromo-1-hexene, 5-chloro-2-methyl-1-pentene, 5-bromo-2-methyl-1-pentene, 4-chloro-2-methyl-1-pentene, 4-bromo-2-methyl-1-pentene, 3-chloro-2-methyl-1-pentene, 3-bromo-2-methyl-1-pentene, 4-chloro-2,3-dimethyl-1-butene, 4-bromo-2,3-dimethyl-1-butene, 2-chloroethyl vinyl ether, 1-chloroethyl vinyl ether, allyl chloromethyl ether, allyl 1-chloroethyl ether, allyl 2-chloroethyl ether, 3-chloro-3-methoxy-1-propene, 3-(3-chloropropoxy)-1-propene, 3-chloro-3-ethoxy-1-propene, 3-(3-chloro-2-methylprpoxy)-1-propene, 2-chloro-1-prop-2-enoxypropane, 1-chloro-1-prop-2-enoxypropane, 1-chloro-2-prop-2-enoxypropane, 2-chloro-2-methyl-1-prop-2-enoxypropane, 2-chloro-3-ethoxy-1-propene, 1-(2-chloroprop-2-enoxy)-2-methylpropane, 1-(chloromethyl)-4-vinylbenzene, 1-(bromomethyl)-4-vinylbenzene, 1-(chloromethyl)-2-vinylbenzene, 1-(bromomethyl)-2-vinylbenzene, 1-(chloromethyl)-3-vinylbenzene, 1-(bromomethyl)-3-vinylbenzene, 1-(chloromethyl)-4-allylbenzene, 1-(bromomethyl)-4-allylbenzene, 1-(chloromethyl)-2-allylbenzene, 1-(bromomethyl)-2-allylbenzene, 1-(chloromethyl)-3-allylbenzene, 1-(bromomethyl)-3-allylbenzene, 4-(3-chloropropyl)styrene, 3-(1-chloroethyl)styrene, 4-chloromethyl-α-methylstyrene, 1-(2-chloropropan-2-yl)-4-prop-en-2-ylbenzene, 1-but-3-enyl-4-(chloromethyl)benzene, 1-vinyloxy-4-chloromethylbenzene, vinyl[4-(chloromethyl)benzyl]ether, 1-allyloxy-2-chloromethylbenzene, 4-allyloxymethylbenzyl chloride, 3-allyloxymethylbenzyl chloride, 1-(2-chloroethoxymethyl)-4-ethenylbenzene, 1-(chloromethoxymethyl)-4-ethenylbenzene, 1-(4-chlorobutoxymethyl)-4-ethenylbenzene, 1-(3-chloroprpoxymethyl)-4-ethenylbenzene, 1-[2-(2-chloroethoxy)ethoxymethyl]-4-ethenylbenzene, 1-[4-(2-chloroethoxy)butoxymethyl]-4-ethenylbenzene, and the likes. The preferred ene monomers can be obtained from the commercial sources or be prepared according to any method known to a person skilled in the art.

Any tertiary-amino-containing acrylic or styrenyl monomer of E₀-L₂-NR₁R₂ can used in the second step in Scheme I to prepare a polysiloxane vinylic monomer of the invention.

Examples of preferred tertiary-amine-containing acrylic monomers include without limitation 2-(dimethylamino)ethyl (meth)acrylate, 2-(diethylamino)ethyl (meth)acrylate, 2-(dipropylamino)ethyl (meth)acrylate, 2-(diisopropylamino)ethyl (meth)acrylate, 2-(dibutylamino)ethyl (meth)acrylate, 2-(diethylamino)-1-methylethyl (meth)acrylate, 2-(2-dimethylaminoethoxy)ethyl (meth)acrylate, N-dimethylaminoethyl (meth)acrylate, 2-(dimethylamino)propyl (meth)acrylate, 2-[2-(diethylamino)ethoxy]ethyl (meth)acrylate, [2-(dipropylamino)-1-methyl]ethyl (meth)acrylate, 3-(dimethylamino)propyl (meth)acrylate, 3-(diethylamino)propyl (meth)acrylate, [3-(dimethylamino)-2,2-dimethyl]propyl (meth)acrylate, N,N-dimethylaminopropyl (meth)acrylate, 4-(dimethylamino)butyl (meth)acrylate, [1-(dimethylamino)-2,2-dimethyl]propyl (meth)acrylate, 3-(dibutylamino)propyl (meth)acrylate, 4-(diethylamino)butyl (meth)acrylate, 3-[ethyl(methyl)amino]propyl (meth)acrylate, 2-[methyl(propyl)amino]ethyl (meth)acrylate, [methyl(propyl)amino]methyl (meth)acrylate, [3-(dimethylamino)-3-methyl]butyl (meth)acrylate, N-[2-(dimethylamino)ethyl] (meth)acrylamide, N-[3-(dimethylamino)propyl] (meth)acrylamide, N-[3-(diethylamino)propyl] (meth)acrylamide, N-[3-(dimethylamino)-2,2-dimethylpropyl] (meth)acrylamide, N-[4-(dimethylamino)butyl](meth)acrylamide, N-[3-(dibutylamino)propyl] (meth)acrylamide, N-{3-[butyl(2-propyl)amino)]propyl} (meth)acrylamide, N-{2-[(bis(2-methylpropyl)amino]ethyl}(meth)acrylamide, N-{3-[methyl(propyl)amino]propyl} (meth)acrylamide, N-[3-(dimethylamino)-1-ethylpropyl] (meth)acrylamide, N-[5-(dipropylamino)pentyl] (meth)acrylamide, and the likes.

Examples of preferred tertiary-amino-containing styrenyl monomers include without limitation di-(C₁-C₄ alkylamino)-substituted styrenes (e.g., 4-dimethylaminostyrene, 3-dimethylaminostyrene, 2-dimethylaminostyrene, 4-dibutylaminostyrene, 4-dipropylaminostyrene, N,N-dimethyl-4-(2-methylprop-2-enyl)aniline, N,N-dimethyl-3-prop-1-en-2-yl)aniline, N,N-dimethyl-2-prop-1-en-2-ylaniline, 2-diethylaminostyrene, etc.), di-(C₁-C₄ alkylamino)(C₁-C₄ alkyl)-substituted styrenes (e.g., N,N-dimethyl-1-(4-vinylphenyl)methanamine, N,N-dimethyl-1-(2-vinylphenyl)methanamine, 1-(3-ethenyl-5-methylphenyl)-N,N-dimethylmethanamine, diethyl(-4-vinylbenzyl)amine, 4-vinylbenzyldiisopropylamine, dialkylaminoethyl-substituted styrenes (N,N-dimethyl-p-vinylphenylethylamine, 1-(4-vinylphenyl)-N,N-dimethylethanamine, n-[(4-ethenylpenyl)methyl}-N,2-dimethylpropan-1-amine, N-[(4-prop-1-en-2-ylphenyl)methyl]-N-propylpropan-1-amine, etc.), and the likes.

Alternatively, a polysiloxane vinylic monomer of formula (1) can be prepared from a mono-tertiary-amino-terminated polydimethylsiloxane by reacting it with a halogen-containing acrylic or styrenyl monomer.

A mono-tertiary-amino-terminated polydimethylsiloxane can be obtained from commercial sources or can be prepared by reacting a mono-hydride-terminated polysiloxane with an ene monomer having a tertiary amino group.

Any ene monomers having a tertiary amino group can be used in the invention. Examples of preferred ene monomers having a tertiary amino group include without limitation N,N-dimethylalyllamine, N,N-diethylaminoallylamine, N-ethylel-N-methylallyamine, N-methyl-N-propylallylamine, N,N-dimethyl(3-butenyl)amine, N,N-dimethylpent-4-en-1-amine, N,ethyl-N-methylbut-3-en-1-amine, N,N,2-trimethylbut-3-en-1-amine, N,N-dimethylpent-4-en-1-amine, N,N-diethylpentenylamine, N-butyl-N-propylpent-4-en-1-amine, N-butyl-N-ethylpent-4-en-1-amine, N,N-dibutylpent-4-en-1-amine, N-methyl-N-propylpent-4-en-1-amine, N-ethyl-N-propylpent-4-en-1-amine, styrenyl monomers having a tertiary amino group as described above, 4-allyl-N,N-dimethylaniline, 4-allyl-N,N-diethylaniline, N,N-dimethyl-4-(3-methylbut-3-enyl)aniline, N,N-dimethyl-3-(2-methylprop-2-enyl)aniline, 4-(but-3-en-1-yl)-N,N-dimethylaniline, etc.

In accordance with the invention, a halogen-containing styrenyl monomer is a halogen-containing-group-substituted styrene which comprises a halogen atom (Cl or Br) a substitutent including a halogen atom (Cl or Br) on aromatic ring. Examples of preferred halogen-containing-group-substituted styrenes include without limitation 1-(chloromethyl)-4-vinylbenzene, 1-(bromomethyl)-4-vinylbenzene, 1-(chloromethyl)-2-vinylbenzene, 1-(bromomethyl)-2-vinylbenzene, 1-(chloromethyl)-3-vinylbenzene, 1-(bromomethyl)-3-vinylbenzene, 4-(3-chloropropyl)styrene, 3-(1-chloroethyl)styrene, 4-chloromethyl-α-methylstyrene, 1-(2-chloropropan-2-yl)-4-prop-en-2-ylbenzene, 1-(2-chloroethoxymethyl)-4-ethenylbenzene, 1-(chloromethoxymethyl)-4-ethenylbenzene, 1-(4-chlorobutoxymethyl)-4-ethenylbenzene, 1-(3-chloroprpoxymethyl)-4-ethenylbenzene, 1-[2-(2-chloroethoxy)ethoxymethyl]-4-ethenylbenzene, 1-[4-(2-chloroethoxy)butoxymethyl]-4-ethenylbenzene, etc.

Examples of preferred acrylic monomers having a halogen atom include without limitation 2-chloroethyl (meth)acrylate, 2-bromoethyl (meth)acrylate, 1-chloroethyl (meth)acrylate, 3-chloropropyl (meth)acrylate, 3-bromopropyl (meth)acrylate, 2-chloropropyloxyethyl (meth)acrylate, 2-(1-chloroethoxy)ethyl (meth)acrylate, 2-(2-chloroethoxy)ethyl (meth)acrylate, 4-(2-chloroethoxy)butyl (meth)acrylate, 2-chloropropyl (meth)acrylate, 1-chloropropan-2-yl (meth)acrylate, 1-chloropropyl (meth)acrylate, 4-bromobutyl (meth)acrylate, 3-bromobutyl (meth)acrylate, 5-bromopentyl (meth)acrylate, 2-bromoethoxy)ethyl (meth)acrylate, N-(2-chloroethyl) (meth)acrylamide, N-(3-chloropropyl) (meth)acrylamide, N-(4-chlorobutyl) (meth)acrylamide, etc.

A polysiloxane vinylic monomer of the invention (formula (1) as defined above) can find particular use in preparing a silicone hydrogel polymeric material, which is another aspect of the invention. A person skilled in the art knows how to prepare a silicone hydrogel polymeric material from a polymerizable composition according to any known polymerization mechanism.

In another aspect, the invention provides a silicone hydrogel contact lens comprising a crosslinked polymeric material comprising: units of a polysiloxane vinylic monomer of the invention (as described above).

In a preferred embodiment, a silicone hydrogel contact lens of the invention, when being fully hydrated, has an oxygen permeability (Dk) of at least about 40 barrers (preferably at least about 60 barrers, more preferably at least about 70 barrers, even more preferably at least about 80 barrers), a water content of from about 15% to about 70% by weight (preferably from about 20% to about 70% by weight, more preferably from about 25% to about 65% by weight, even more preferably from about 30% to about 60% by weight), an elastic modulus of from about 0.20 MPa to about 1.8 MPa (preferably from about 0.25 MPa to about 1.5 MPa, more preferably from about 0.3 MPa to about 1.2 MPa, even more preferably from about 0.4 MPa to about 1.0 MPa).

A person skilled in the art knows well how to measure the oxygen permeability, oxygen transmissibility, water content, and elastic modulus of silicone hydrogel contact lenses. These lens properties have been reported by all manufacturers for their silicone hydrogel contact lens products.

A silicone hydrogel contact lens of the invention also comprises: units of at least one vinylic crosslinker which comprises at least one polysiloxane vinylic crosslinker and/or at least one non-silicone vinylic crosslinker; and units of at least one hydrophilic vinylic monomer.

Any suitable polysiloxane vinylic crosslinkers can be used in the invention. Examples of preferred polysiloxane vinylic crosslinkers are di-(meth)acryloyl-terminated polydimethylsiloxanes; di-vinyl carbonate-terminated polydimethylsiloxanes; di-vinyl carbamate-terminated polydimethylsiloxane; N,N,N′,N′-tetrakis(3-methacryloxy-2-hydroxypropyl)-alpha,omega-bis-3-aminopropyl-polydimethylsiloxane; polysiloxane-containing macromer selected from the group consisting of Macromer A, Macromer B, Macromer C, and Macromer D described in U.S. Pat. No. 5,760,100; polysiloxane-containing macromers disclosed in U.S. Pat. Nos. 4,136,250, 4,153,641, 4,182,822, 4,189,546, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,451,617, 5,486,579, 5,962,548, 5,981,675, 6,039,913, and 6,762,264; polysiloxane-containing macromers disclosed in U.S. Pat. Nos. 4,259,467, 4,260,725, and 4,261,875.

One class of preferred polysiloxane vinylic crosslinkers are di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 2 to 6 hydroxyl groups, more preferably a polysiloxane vinylic crosslinker of formula (1), are described later in this application and can be prepared according to the procedures disclosed in U.S. patent Ser. No. 10/081,697.

Another class of preferred polysiloxane vinylic crosslinkers are vinylic crosslinkers each of which comprises one sole polydiorganosiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino-terminated polydimethylsiloxane in the presence of a coupling agent (a carbodiimide); or prepared by reacting a hydroxyl-containing acrylic monomer with a di-hydroxy-terminated polydisiloxane in the presence of a diisocyanate or di-epoxy coupling agent.

Other classes of preferred polysiloxane vinylic crosslinkers are chain-extended polysiloxane vinylic crosslinkers each of which has at least two polydiorganosiloxane segments linked by a linker between each pair of polydiorganosiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 10,301,451, and 10,465,047.

Any non-silicone vinylic crosslinkers can be in this invention. Examples of preferred non-silicone vinylic cross-linking agents are described later in this application.

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers(as described later in this application), N-2-hydroxyethyl vinyl carbamate, N-carboxyvinyl-β-alanine (VINAL), N-carboxyvinyl-α-alanine, and combinations thereof.

A silicone hydrogel contact lens of the invention can also further comprise: units of at least one hydrophobic vinylic monomer; at least one siloxane-containing vinylic monomer, or combinations thereof.

Any hydrophobic vinylic monomers can be in this invention. Examples of preferred hydrophobic vinylic monomers include methyl (meth)acrylate, ethyl (meth)acrylate, propyl (meth)acrylate, isopropyl (meth)acrylate, cyclohexyl (meth)acrylate, 2-ethylhexyl (meth)acrylate, vinyl acetate, vinyl propionate, vinyl butyrate, vinyl valerate, styrene, chloroprene, vinyl chloride, vinylidene chloride, (meth)acrylonitrile, 1-butene, butadiene, vinyl toluene, vinyl ethyl ether, perfluorohexylethyl-thio-carbonyl-aminoethyl-methacrylate, isobornyl (meth)acrylate, trifluoroethyl (meth)acrylate, hexafluoro-isopropyl (meth)acrylate, hexafluorobutyl (meth)acrylate, and combinations thereof.

Any suitable siloxane-containing vinylic monomers can be used in the invention. Examples of preferred silicone-containing vinylic monomers include without limitation vinylic monomers each having a bis(trialkylsilyloxy)alkylsilyl group or a tris(trialkylsilyloxy)silyl group, polysiloxane vinylic monomers, and combinations thereof.

Preferred polysiloxanes vinylic monomers including those of formula (M1) are described later in this application and can be obtained from commercial suppliers (e.g., Shin-Etsu, Gelest, etc.); prepared according to procedures described in patents, e.g., U.S. Pat. Nos. 5,070,215, 6,166,236, 6,867,245, 8,415,405, 8,475,529, 8,614,261, and 9,217,813; prepared by reacting a hydroxyalkyl (meth)acrylate or (meth)acrylamide or a (meth)acryloxypolyethylene glycol with a mono-epoxypropyloxypropyl-terminated polydimethylsiloxane; prepared by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane; or prepared by reacting isocyanatoethyl (meth)acrylate with a mono-carbinol-terminated polydimethylsiloxane according to coupling reactions well known to a person skilled in the art.

Preferred siloxane-containing vinylic monomers each having a bis(trialkylsilyloxy)alkylsilyl group or a tris(trialkylsilyloxy)silyl group, including those of formula (M2), are described later in this application and can be obtained from commercial suppliers (e.g., Shin-Etsu, Gelest, etc.) or can be prepared according to procedures described in U.S. Pat. Nos. 5,070,215, 6,166,236, 7,214,809, 8,475,529, 8,658,748, 9,097,840, 9,103,965, and 9,475,827.

In accordance with the invention, a silicone hydrogel (SiHy) contact lens of the invention can be produced according to any lens manufacturing processes. A person skilled in the art knows very well how to make SiHy contact lenses. For example, SiHy contact lenses can be produced in a conventional “spin-casting mold,” as described for example in U.S. Pat. No. 3,408,429, or by the full cast-molding process in a static form, as described in U.S. Pat. Nos. 4,347,198; 5,508,317; 5,583,463; 5,789,464; and 5,849,810, or by lathe cutting of polymeric material buttons as used in making customized contact lenses. In cast-molding, a polymerizable composition (i.e., a SiHy lens formulation) typically is dispensed into molds and cured (i.e., polymerized and/or crosslinked) in molds for making SiHy contact lenses.

Lens molds for making contact lenses including SiHy contact lenses are well known to a person skilled in the art and, for example, are employed in cast molding or spin casting. For example, a mold (for cast molding) generally comprises at least two mold sections (or portions) or mold halves, i.e., first and second mold halves. The first mold half defines a first molding (or optical) surface and the second mold half defines a second molding (or optical) surface. The first and second mold halves are configured to receive each other such that a lens forming cavity is formed between the first molding surface and the second molding surface. The molding surface of a mold half is the cavity-forming surface of the mold and in direct contact with the polymerizable composition.

Methods of manufacturing mold sections for cast-molding a contact lens are generally well known to those of ordinary skill in the art. The process of the present invention is not limited to any particular method of forming a mold. In fact, any method of forming a mold can be used in the present invention. The first and second mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making molds can be used to make molds for making contact lenses. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the invention, the polymerizable composition can be introduced (dispensed) into a cavity formed by a mold according to any known methods.

After the polymerizable composition is dispensed into the mold, it is polymerized to produce a SiHy contact lens. Crosslinking may be initiated thermally or actinically, preferably by exposing the polymerizable composition in the mold to a spatial limitation of actinic radiation to crosslink the polymerizable components in the polymerizable composition.

Opening of the mold so that the molded SiHy contact lens can be removed from the mold may take place in a manner known per se.

The molded SiHy contact lenses can be subject to lens extraction with a liquid extraction medium to remove unpolymerized polymerizable components and formed and oligomers. In accordance with the invention, the extraction liquid medium is any solvent capable of dissolving the organic solvent, unpolymerized polymerizable materials, and oligomers in the dry contact lens. Water, any organic solvents known to a person skilled in the art, or a mixture thereof can be used in the invention. Preferably, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

After extraction, silicone hydrogel contact lens can be hydrated in water or an aqueous solution to replace the liquid extraction medium, according to any method known to a person skilled in the art.

The hydrated silicone hydrogel contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

A SiHy contact lens formulation can also comprise other necessary components known to a person skilled in the art, such as, for example, free-radical initiators (e.g., thermal polymerization initiators, photoinitiators), a UV-absorbing vinylic monomer, a high-energy-violet-light (“HEVL”) absorbing vinylic monomer, a visibility tinting agent (e.g., reactive dyes, polymerizable dyes, pigments, antimicrobial agents (e.g., preferably silver nanoparticles), a bioactive agent, leachable polymeric wetting agents (e.g., non-polymerizable hydrophilic polymers, etc.), leachable tear-stabilizing agents (e.g., phospholipids, monoglycerides, diglycerides, triglycerides, glycolipids, glyceroglycolipids, sphingolipids, sphingo-glycolipids, etc.), and mixtures thereof, as known to a person skilled in the art.

Any thermal polymerization initiators can be used in the invention. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173@ and Darocur 2959@, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators which can be incorporated, for example, into a macromer or can be used as a special monomer are also suitable. Examples of reactive photoinitiators are those disclosed in EP 632 329. Preferably, a SiHy lens formulation for making a SiHy contact lenses comprises at least one photoinitiator which can be initiated by visible lights, such as, benzoylphosphine oxide photoinitiators, Germanium-based Norrish Type I photoinitiators, or combinations thereof.

A polymerizable composition (SiHy lens formulation) can be a solventless clear liquid prepared by mixing all polymerizable components and other necessary component or a solution prepared by dissolving all of the desirable components in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction.

A solventless lens SiHy lens formulation typically comprises at least one blending vinylic monomer as a reactive solvent for dissolving all other polymerizable components of the solventless SiHy lens formulation. Examples of preferred blending vinylic monomers are described later in this application. Preferably, methyl methacrylate is used as a blending vinylic monomer in preparing a solventless SiHy lens formulation.

Any solvents can be used in the invention. Example of preferred organic solvents includes without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-pyrrolidone, N,N-dimethylpropionamide, dimethyl formamide, dimethyl acetamide, dimethyl propionamide, N-methyl pyrrolidinone, and mixtures thereof.

A SiHy lens formulation (i.e., polymerizable composition) can be cured (polymerized) thermally or actinically as known to a person skilled in the art, preferably in molds for cast molding of contact lenses.

The thermal polymerization is carried out conveniently, for example at a temperature of from 25 to 120° C. and preferably 40 to 100° C. The reaction time may vary within wide limits, but is conveniently, for example, from 1 to 24 hours or preferably from 2 to 12 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example light, in particular UV light or visible light of a suitable wavelength. The spectral requirements can be controlled accordingly, if appropriate, by addition of suitable photosensitizers.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:
1. A polysiloxane vinylic monomer, (1) a polysiloxane polymer chain comprising at least 5 dimethylsiloxane units in a consecutive sequence; (2) one sole terminal ethylenically unsaturated group; and (3) a quaternary ammonium moiety.
2. The polysiloxane vinylic monomer of embodiment 1, wherein the polysiloxane vinylic monomer is represented by formula (1)

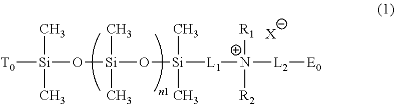

in which:
   T₀ is a linear or branched C₁-C₆ alkyl which is optionally substituted with a hydroxyl or C₁-C₃ alkoxy group;
   X^{⊖} is a counter anion;
   R₁ and R₂ independent of each other are a C₁-C₄ alkyl
   E₀ is a monovalent radical of

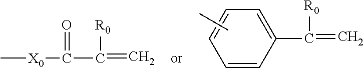

R₀ is hydrogen or methyl;
a₀ is zero or 1;
X₀ is O or NR_{N1};
R_{N1} is hydrogen or a C₁-C₆ alkyl;
n1 is an integer of from 4 to 50;
L₁ is a divalent radical of

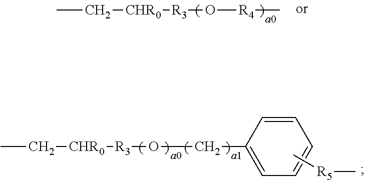

a₀ and a₁ independent of each other are zero or 1;
R₃ and R₅ independent of each other are a direct bond or a linear or branched C₁-C₃ alkylene divalent radical which is optionally substituted with C₁-C₄ alkoxy group or hydroxyl group;
R₄ is a linear or branched C₁-C₆ alkylene divalent radical which is optionally substituted with C₁-C₄ alkoxy group or hydroxyl group;
R₅ is a direct bond, a linear or branched C₁-C₃ alkylene divalent radical which is optionally substituted with C₁-C₄ alkoxy group or hydroxyl group, or a divalent radical of

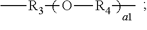

L₂ is either a linear or branched C₁-C₆ alkylene divalent radical which is optionally substituted with C₁-C₃ alkoxy or hydroxyl group or a divalent radical of

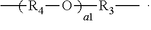

3. The polysiloxane vinylic monomer of embodiment 1 or 2, wherein in formula (1) E₀ is a monovalent radical of

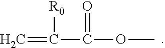

4. The polysiloxane vinylic monomer of embodiment 1 or 2, wherein in formula (1) E₀ is a monovalent radical of

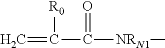

in which R_{N1} is hydrogen or a C₁-C₆ alkyl.
5. The polysiloxane vinylic monomer of embodiment 1 or 2, wherein in formula (1) E₀ is a monovalent radical of

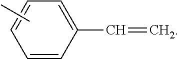

6. The polysiloxane vinylic monomer of any one of embodiments 1 to 5, wherein in formula (1) n1 is from 4 to 40.
7. The polysiloxane vinylic monomer of any one of embodiments 1 to 5, wherein in formula (1) n1 is from 4 to 30.
8. The polysiloxane vinylic monomer of any one of embodiments 1 to 5, wherein in formula (1) n1 is from 4 to 20.
9. The polysiloxane vinylic monomer of any one of embodiments 1 to 5, wherein in formula (1) n1 is from 4 to 15.
10. A silicone hydrogel contact lens, comprising a silicone hydrogel bulk material which comprises repeating units of a polysiloxane vinylic monomer of any one of embodiments 1 to 9.
11. The silicone hydrogel contact lens of embodiment 10, wherein the silicone hydrogel contact lens, when being fully hydrated, has an oxygen permeability (Dk) of at least about 40 barrers, a water content of from about 15% to about 70% by weight, and an elastic modulus of from about 0.20 MPa to about 1.8 MPa.
12. The silicone hydrogel contact lens of embodiment 10 or 11, wherein the silicone hydrogel bulk material also comprises: repeating units of units of at least one vinylic crosslinker which comprises at least one polysiloxane vinylic crosslinker and/or at least one non-silicone vinylic crosslinker; and units of at least one hydrophilic vinylic monomer.
13. The silicone hydrogel contact lens of embodiment 12, wherein said at least one vinylic crosslinker comprises at least one polysiloxane vinylic crosslinker.
14. The silicone hydrogel contact lens of embodiment 13, wherein said at least one polysiloxane vinylic crosslinker comprises a di-(meth)acryloyl-terminated polydimethylsiloxane, a di-vinyl carbonate-terminated polydimethylsiloxane; a di-vinyl carbamate-terminated polydimethylsiloxane; N,N,N′,N′-tetrakis(3-methacryloxy-2-hydroxypropyl)-alpha,omega-bis-3-aminopropyl-polydimethylsiloxane, or a combination thereof.
15. The silicone hydrogel contact lens of embodiment 13 or 14, wherein said at least one polysiloxane vinylic crosslinker comprises a vinylic crosslinker of formula (I)

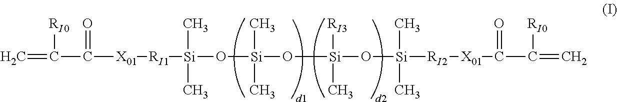

in which:
   d1 is an integer of from 30 to 500 and d2 is an integer of from 1 to 75, provided that d2/d1 is from about 0.035 to about 0.15 (preferably from about 0.040 to about 0.12, even more preferably from about 0.045 to about 0.10);
   X₀₁ is O or NR_{IN} in which R_{IN} is hydrogen or C₁-C₁₀-alkyl;
   Rₗ₀ is hydrogen or methyl;
   Rₗ₁ and Rₗ₂ independently of each other are a substituted or unsubstituted C₁-C₁₀ alkylene divalent radical or a divalent radical of —R₁₄—O—R₁₅— in which R₁₄ and R₁₅ independently of each other are a substituted or unsubstituted C₁-C₁₀ alkylene divalent radical;
   Rₗ₃ is a monovalent radical of any one of formula (Ia) to (Ie)

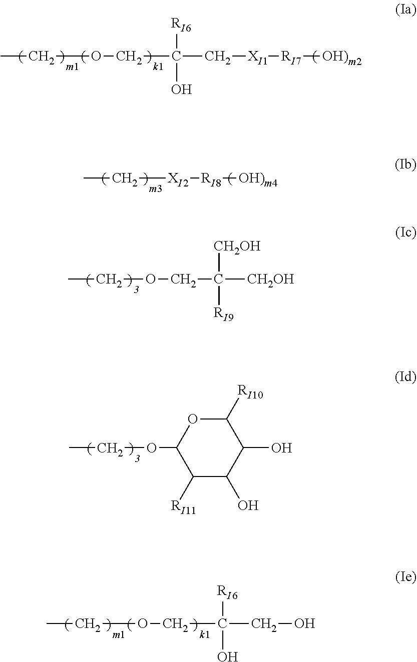

k1 is zero or 1; m1 is an integer of 2 to 4; m2 is an integer of 1 to 5; m3 is an integer of 3 to 6; m4 is an integer of 2 to 5;
Rₗ₆ is hydrogen or methyl;
Rₗ₇ is a C₂-C₆ hydrocarbon radical having (m2+1) valencies;
Rₗ₈ is a C₂-C₆ hydrocarbon radical having (m4+1) valencies;
Rₗ₉ is ethyl or hydroxymethyl;
Rₗ₁₀ is methyl or hydroxymethyl;
Rₗ₁₁ is hydroxyl or methoxy;
Xₗ₁ is a sulfur linkage of —S— or a teriary amino linkage of —NRₗ₁₂— in which Rₗ₁₂ is C₁-C₁ alkyl, hydroxyethyl, hydroxypropyl, or 2,3-dihydroxypropyl; and
X₁₂ is an amide linkage of

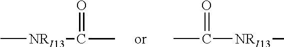

in which Rₗ₁₃ is hydrogen or C₁-C₁₀ alkyl.
16. The silicone hydrogel contact lens of any one of embodiments 13 to 15, wherein said at least one polysiloxane vinylic crosslinker comprises: (1) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (2) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.
17. The silicone hydrogel contact lens of any one of embodiments 13 to 16, wherein said at least one polysiloxane vinylic crosslinker comprises α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.
18. The silicone hydrogel contact lens of any one of embodiments 12 to 17, wherein the silicone hydrogel bulk material comprises said at least one hydrophilic vinylic monomer comprises: (1) an alkyl (meth)acrylamide selected from the group consisting of (meth)acrylamide, N,N-dimethyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof; (2) a hydroxyl-containing acrylic monomer selected from the group consisting of N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof; (3) a carboxyl-containing acrylic monomer selected from the group consisting of 2-(meth)acrylamidoglycolic acid, (meth)acrylic acid, ethylacrylic acid, 3-(emth)acrylamidopropionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(emth)acrylamido-2methyl-3,3-dimethyl butanoic acid, 3-(meth)acrylamidohaxanoic acid, 4-(meth)acrylamido-3,3-dimethylhexanoic acid, and combinations thereof; (4) an amino-containing acrylic monomer selected from the group consisting of N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof; (5) an N-vinyl amide monomer selected from the group consisting of N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof; (6) a methylene-containing pyrrolidone monomer selected from the group consisting of 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and combinations thereof; (7) an acrylic monomer having a C₁-C₄ alkoxyethoxy group and selected from the group consisting of ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof; (8) a vinyl ether monomer selected from the group consisting of ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof; (9) an allyl ether monomer selected from the group consisting of ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof; (10) a phosphorylcholine-containing vinylic monomer selected from the group consisting of (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2-(trimethylammonio)-ethylphosphate, 3-[(meth)acryloylamino]propyl-2-(trimethylammonio)ethylphosphate, 4-[(meth)acryloylamino]butyl-2′-(trimethylammonio)ethylphosphate, 5-((meth)acryloyloxy)pentyl-2′-(trirnethylammonio)ethyl phosphate, 6-((meth)acryloyloxy)hexyl-2′-(trimethylammonio)-ethylphosphate, 2-((meth)acryloyloxy)ethyl-2′-(triethylammonio)ethylphosphate, 2-((meth)acryloyloxy)ethyl-2-(tripropylammonio)ethylphosphate, 2-((meth)acryloyloxy)ethyl-2′-(tributylammonio)ethyl phosphate, 2-((meth)acryloyloxy)propyl-2′-(trimethylammonio)-ethylphosphate, 2-((meth)acryloyloxy)butyl-2-(trimethylammonio)ethylphosphate, 2-((meth)acryloyloxy)pentyl-2′(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2-(trimethylammonio)-ethylphosphate, 2-(vinylcarbonylamino)ethyl-2′-(trimethylammonio)ethylphosphate, 2-(allyloxycarbonylamino)ethyl-2-(trimethylammonio)ethyl phosphate, 2-(butenoyloxy)ethyl-2′-(trimethylammonio)ethylphosphate, and combinations thereof; (11) allyl alcohol; (12)N-2-hydroxyethyl vinyl carbamate; (13)N-carboxyvinyl-β-alanine (VINAL); (14)N-carboxyvinyl-α-alanine; (15) or combinations thereof.
19. The silicone hydrogel contact lens of any one of embodiments 12 to 17, wherein said at least one hydrophilic vinylic monomer comprises N-vinylpyrrolidone, N-vinyl-N-methyl acetamide, or combinations thereof.
20. The silicone hydrogel contact lens of any one of embodiments 12 to 19, wherein said at least one hydrophilic vinylic monomer comprises N,N-dimethyl (meth)acrylamide.
21. The silicone hydrogel contact lens of any one of embodiments 12 to 20, wherein said at least one hydrophilic vinylic monomer comprises N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, or combinations thereof.
22. The silicone hydrogel contact lens of any one of embodiments 13 to 21, wherein said at least one vinylic crosslinker comprises at least non-silicone vinylic crosslinker.
23. The silicone hydrogel contact lens of embodiment 22, wherein said at least one non-silicone vinylic crosslinker comprises ethyleneglycol di-(meth)acrylate, diethyleneglycol di-(meth)acrylate, triethyleneglycol di-(meth)acrylate, tetraethyleneglycol di-(meth)acrylate, glycerol di-(meth)acrylate, 1,3-propanediol di-(meth)acrylate, 1,3-butanediol di-(meth)acrylate, 1,4-butanediol di-(meth)acrylate, glycerol 1,3-diglycerolate di-(meth)acrylate, ethylenebis[oxy(2-hydroxypropane-1,3-diyl)] di-(meth)acrylate, bis[2-(meth)acryloxyethyl] phosphate, trimethylolpropane di-(meth)acrylate, and 3,4-bis[(meth)acryloyl]tetrahydrofuan, diacrylamide, dimethacrylamide, N,N-di(meth)acryloyl-N-methylamine, N,N-di(meth)acryloyl-N-ethylamine, N,N′-methylene bis(meth)acrylamide, N,N′-ethylene bis(meth)acrylamide, N,N′-dihydroxyethylene bis(meth)acrylamide, N,N′-propylene bis(meth)acrylamide, N,N′-2-hydroxypropylene bis(meth)acrylamide, N,N′-2,3-dihydroxybutylene bis(meth)acrylamide, 1,3-bis(meth)acrylamidepropane-2-yl dihydrogen phosphate, piperazine diacrylamide, tetraethyleneglycol divinyl ether, triethyleneglycol divinyl ether, diethyleneglycol divinyl ether, ethyleneglycol divinyl ether, triallyl isocyanurate, triallyl cyanurate, trimethylopropane trimethacrylate, pentaerythritol tetramethacrylate, bisphenol A dimethacrylate, allylmethacrylate, allylacrylate, N-allyl-methacrylamide, N-allyl-acrylamide, or combinations thereof.
24. The silicone hydrogel contact lens of any one of embodiments 12 to 23, wherein the silicone hydrogel bulk material further comprises repeating units of at least one silicone-containing vinylic monomer selected from the group consisting of a vinylic monomer having a bis(trialkylsilyloxy)alkylsilyl group, a vinylic monomer having a tris(trialkylsilyloxy)silyl group, a second polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.
25. The silicone hydrogel contact lens of any one of embodiments 12 to 23, wherein the silicone hydrogel bulk material further comprises repeating units of at least one silicone-containing vinylic monomer of formula (M1) or (M2)

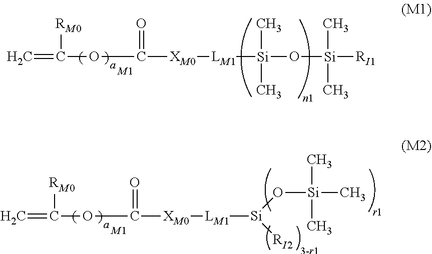

in which: a_{M1} is zero or 1; R_{M0} is H or methyl; X_{M0} is O or NR_{M1}; L_{M1} is a C₂-C₈ alkylene divalent radical or a divalent radical of -L_{M1}′-X_{M1}-L_{M1}″-,

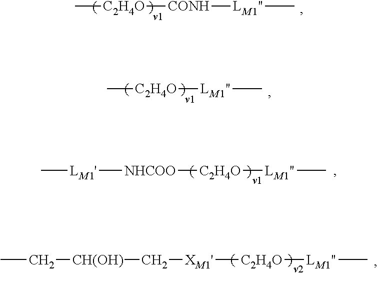

-L_{M1}′-X_{M1}′-CH₂—CH(OH)—CH₂—O-L_{M1}″-, or

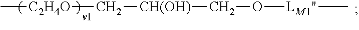

L_{M1}′ is a C₂-C₈ alkylene divalent radical which has zero or one hydroxyl group; L_{M1}″ is C₃-C₈ alkylene divalent radical which has zero or one hydroxyl group; X_{M1} is O, NR_{M1}, NHCOO, OCONH, CONR_{M1}, or NR_{M1}CO; R_{M1} is H or a C₁-C₄ alkyl having 0 to 2 hydroxyl group; Rₜ₁ and Rₜ₂ independent of each other are a C₁-C₆ alkyl; X_{M1}′ is O or NR₁; v1 is an integer of 1 to 30; v2 is an integer of 0 to 30; n1 is an integer of 3 to 40; and r1 is an integer of 2 or 3.
26. The silicone hydrogel contact lens of any one of embodiments 12 to 23, wherein the silicone hydrogel bulk material further comprises tris(trimethylsilyloxy)silylpropyl (meth)acrylate, [3-(meth)acryloxy-2-hydroxypropyloxy]propylbis(trimethylsiloxy)methylsilane, [3-(meth)acryloxy-2-hydroxypropyloxy]propylbis(trimethylsiloxy)butylsilane, 3-(meth)acryloxy-2-(2-hydroxyethoxy)-propyloxy)propylbis(trimethylsiloxy)methylsilane, 3-(meth)acryloxy-2-hydroxypropyloxy)propyltris(trimethylsiloxy)silane, N-[tris(trimethylsiloxy)silylpropyl]-(meth)acrylamide, N-(2-hydroxy-3-(3-(bis(trimethylsilyloxy)methylsilyl)propyloxy)propyl)-2-methyl (meth)acrylamide, N-(2-hydroxy-3-(3-(bis(trimethylsilyloxy)methylsilyl)propyloxy)-propyl) (meth)acrylamide, N-(2-hydroxy-3-(3-(tris(trimethylsilyloxy)silyl)propyloxy)propyl)-2-methyl acrylamide, N-(2-hydroxy-3-(3-(tris(trimethylsilyloxy)silyl)propyloxy)propyl) (meth)acrylamide, N-[tris(dimethylpropylsiloxy)silylpropyl]-(meth)acrylamide, N-[tris(dimethylphenylsiloxy)-silylpropyl] (meth)acrylamide, N-[tris(dimethylethylsiloxy)-silylpropyl] (meth)acrylamide, N,N-bis[2-hydroxy-3-(3-(bis(trimethylsilyloxy)methylsilyl)-propyloxy)propyl]-2-methyl (meth)acrylamide, N,N-bis[2-hydroxy-3-(3-(bis(trimethylsilyloxy)methylsilyl)propyloxy)-propyl] (meth)acrylamide, N,N-bis[2-hydroxy-3-(3-(tris(trimethylsilyloxy)silyl)propyloxy)-propyl]-2-methyl (meth)acrylamide, N,N-bis[2-hydroxy-3-(3-(tris(trimethylsilyloxy)silyl)-propyloxy)propyl] (meth)acrylamide, N-[2-hydroxy-3-(3-(t-butyldimethylsilyl)propyloxy)-propyl]-2-methyl (meth)acrylamide, N-[2-hydroxy-3-(3-(t-butyldimethylsilyl)propyloxy)-propyl] (meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)-propyl-tris(trimethyl-siloxy)silane, 3-[tris(trimethylsiloxy)silyl]propylvinyl carbamate, 3-[tris(trimethylsiloxy)silyl] propyl allyl carbamate, 3-[tris(trimethylsiloxy)silyl]propyl vinyl carbonate, or a combination thereof.
27. The silicone hydrogel contact lens of any one of embodiments 12 to 23, wherein the silicone hydrogel bulk material further comprises α-(meth)acryloxypropyl terminated ω-C₁-C₄-alkyl terminated polydimethylsiloxane, α-(meth)acryloxy-2-hydroxypropyloxypropyl terminated ω-C₁-C₄-alkyl terminated polydimethylsiloxane, α-(2-hydroxyl-methacryloxypropyloxypropyl)-ω-C₁-C₄-alkyl-decamethylpentasiloxane, α-[3-(meth)acryloxyethoxy-2-hydroxypropyloxypropyl]-terminated ω-C₁-C₄-alkyl terminated polydimethylsiloxane, α-[3-(meth)acryloxy-propyloxy-2-hydroxypropyloxypropyl]-terminated ω-C₁-C₄-alkyl terminated polydimethylsiloxane, α-[3-(meth)acryloxyisopropyloxy-2-hydroxypropyloxypropyl]-terminated ω-C₁-C₄-alkyl terminated polydimethylsiloxane, α-[3-(meth)acryloxybutyloxy-2-hydroxypropyloxypropyl]-terminated ω-C₁-C₄-alkyl terminated polydimethylsiloxane, α-[3-(meth)acryloxyethylamino-2-hydroxypropyloxypropyl]-terminated ω-C₁-C₄-alkyl terminated polydimethylsiloxane, α-[3-(meth)acryloxypropylamino-2-hydroxypropyloxypropyl]-terminated ω-C₁-C₄-alkyl terminated polydimethylsiloxane, α-[3-(meth)acryloxy-butylamino-2-hydroxypropyloxypropyl]-terminated ω-C₁-C₄-alkyl terminated polydimethylsiloxane, α-(meth)acryloxy(polyethylenoxy)-2-hydroxypropyloxypropyl]-terminated ω-C₁-C₄-alkyl terminated polydimethylsiloxane, α-[(meth)acryloxy-2-hydroxypropyloxy-ethoxypropyl]-terminated ω-C₁-C₄-alkyl terminated polydimethylsiloxane, α-[(meth)acryloxy-2-hydroxypropyl-N-ethylaminopropyl]-terminated ω-C₁-C₄-alkyl terminated polydimethylsiloxane, α-[(meth)acryloxy-2-hydroxypropyl-aminopropyl]-terminated ω-C₁-C₄-alkyl terminated polydimethylsiloxane, α-[(meth)acryloxy-2-hydroxypropyloxy-(polyethylenoxy)propyl]-terminated ω-C₁-C₄-alkyl terminated polydimethylsiloxane, α-(meth)acryloylamidopropyloxypropyl terminated ω-C₁-C₄-alkyl terminated polydimethylsiloxane, α-N-methyl-(meth)acryloylamidopropyloxypropyl terminated ω-C₁-C₄-alkyl terminated polydimethylsiloxane, α-[3-(meth)acrylamidoethoxy-2-hydroxypropyloxy-propyl]-terminated ω-C₁-C₄-alkyl polydimethylsiloxane, α-[3-(meth)acrylamidopropyloxy-2-hydroxypropyloxypropyl]-terminated ω-C₁-C₄-alkyl terminated polydimethylsiloxane, α-[3-(meth)acrylamidoisopropyloxy-2-hydroxypropyloxypropyl]-terminated ω-C₁-C₄-alkyl terminated polydimethylsiloxane, α-[3-(meth)acrylamidobutyloxy-2-hydroxypropyloxypropyl]-terminated ω-C₁-C₄-alkyl terminated polydimethylsiloxane, α-[3-(meth)acryloylamido-2-hydroxypropyloxypropyl] terminated ω-C₁-C₄-alkyl polydimethylsiloxane, α-[3-[N-methyl-(meth)acryloylamido]-2-hydroxypropyloxypropyl]terminated ω-C₁-C₄-alkyl terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamidopropyltetra(dimethylsiloxy)dimethylbutylsilane, α-vinyl carbonate-terminated ω-C₁-C₄-alkyl-terminated polydimethylsiloxanes, α-vinyl carbamate-terminated ω-C₁-C₄-alkyl-terminated polydimethylsiloxane, or a mixture thereof.
28. The silicone hydrogel contact lens of any one of embodiments 12 to 27, wherein the silicone hydrogel bulk material further comprises repeating units of at least one blending vinylic monomer.
29. The silicone hydrogel contact lens of embodiment 28, wherein said at least one blending vinylic monomer comprises C₁-C₁₀ alkyl (meth)acrylate, cyclopentylacrylate, cyclohexylmethacrylate, cyclohexylacrylate, isobornyl (meth)acrylate, styrene, 4,6-trimethylstyrene (TMS), t-butyl styrene (TBS), trifluoroethyl (meth)acrylate, hexafluoro-isopropyl (meth)acrylate, hexafluorobutyl (meth)acrylate, or combinations thereof.
30. The silicone hydrogel contact lens of embodiment 28 or 29, wherein said at least one blending vinylic monomer comprises methyl methacrylate.
31. The silicone hydrogel contact lens of any one of embodiments 12 to 30, wherein the silicone hydrogel bulk material further comprises units of a UV-absorbing vinylic monomer and/or a UV/HEVL-absorbing vinylic monomer.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the apparent oxygen permeability (Dkₐₚₚ), the apparent oxygen transmissibility (Dk/t), the intrinsic (or edge-corrected) oxygen permeability (Dk_{c}) of a lens and a lens material are determined according to procedures described in Example 1 of U.S. patent application publication No. 2012/0026457 A1.

### Example 2

### Synthesis of Quaternary Ammonium Containing PDMS Vinylic Monomer

A polysiloxane vinylic monomer is prepared according to the procedures shown in Scheme 1

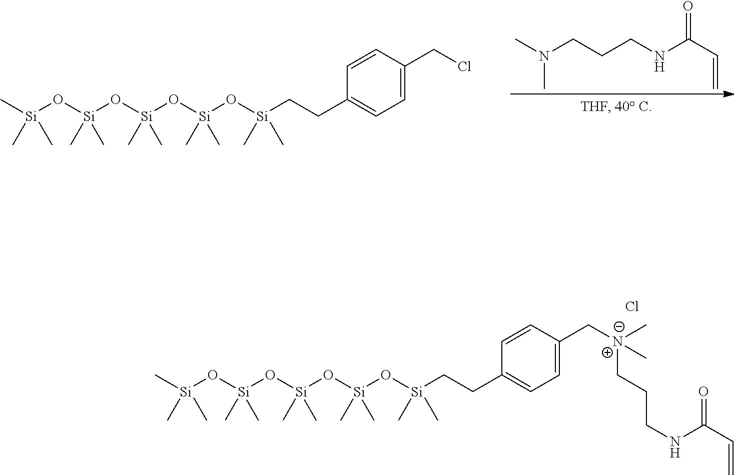

Benzyl chloride containing polydimethylsiloxane, methyl- and 2-[4-(chloromethyl)-phenyl]ethyl-terminated polydimethylsiloxane (10.13 g, 19.36 mmol), is charged into a 100 mL round bottom flask equipped with magnetic stirrer and rubber septum. 40 mL of tetrahydrofuran (THF) is added through a septum via syringe. 3-(Dimethylamino)propyl acrylamide (3.10 g, 19.84 mmol) is dissolved in 10-15 mL of THF in a scintillation vial and then added to the flask via syringe. Reaction flask is placed in sand bath heated to 40° C. and it is allowed to stir for 18 hours. Reaction mixture is passed through a silica gel column (1.5 in ×12 in; CHCl₃→CHCl₃:MeOH 100→85:15). The solvent is removed by rotary evaporation and the residue is dried by oil pump vacuum for 3 h to give 10.30 g (15.15 mmol, 78%) of the final product as a thick paste.

¹H-NMR (600 MHz, CDCl₃): δ=8.82-8.74 (m, 1H), 7.42 (d, 2H, J=8.0 Hz), 7.25 (d, 2H, J=8.0 Hz), 6.47 (dd, 1H, J=17.1, 10.3 Hz), 6.26 (dd, 1H, J=17.1, 1.3 Hz), 5.54 (dd, 1H, J=10.3, 1.3 Hz), 4.66 (s, 2H), 3.82-3.76 (m, 2H), 3.46-3.42 (m, 2H), 3.41 (s, 6H), 2.68-2.62 (m, 2H), 2.25-2.18 (m, 2H), 0.89-0.84 (m, 2H), 0.15-0.02 (m, 33H).

### Example 3

### Solubility of Quaternary Ammonium Containing PDMS Vinylic Monomer

The solubility of quaternium ammonium containing PDMS vinylic monomer prepared in Example 2 is evaluated in 1-PrOH:Water mixtures. Typically, 50-60 mg of the sample is combined with a selected solvent system and it is stirred/agitated at room temperature. After few minutes compatibility is evaluated. For comparison, the solubilities of three reference materials are also evaluated. The three reference material are: methacryloxypropyl- and n-butyl-terminated polydimiethylsiloxane (D6, Mₙ=700-800 g/mol) (Ref. 1); methacryloxypropyl- and n-butyl-terminated polydimiethylsiloxane (D9, Mₙ=900-1,000 g/mol) (Ref. 2); and methyl- and 2-[4-(chloromethyl)phenyl]ethyl-terminated polydimethylsiloxane (Ref. 3). Results are presented in Table 1.

TABLE 1

| | | | | Compound from |
|---|---|---|---|---|
| 1-PrOH:Water | Ref. 1 | Ref. 2 | Ref. 3 | Example 2 |
| 100:0 | Clear | | | |
| 80:20 | Clear | Hazy | Clear | Clear |

| | | |
|---|---|---|
| 60:40 | Hazy | Clear |
| 40:60 | Hazy | Clear |

| | |
|---|---|
| 20:80 | Hazy |
| 0:100 | Hazy |

Ref. 1 (D6) and Ref. 2 (D9) 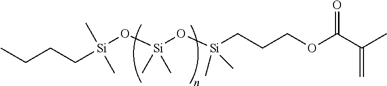
Ref. 3 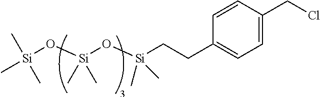
Compound of Example 2

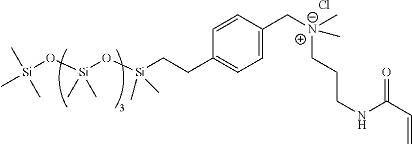

All the publications, patents, and patent application publications, which have been cited herein above in this application, are hereby incorporated by reference in their entireties.

What is claimed is:

1. A polysiloxane vinylic monomer, (1) a polysiloxane polymer chain comprising at least 5 dimethylsiloxane units in a consecutive sequence; (2) one sole terminal ethylenically unsaturated group; and (3) a quaternary ammonium moiety.

2. The polysiloxane vinylic monomer of claim 1, wherein the polysiloxane vinylic monomer is represented by formula (1) 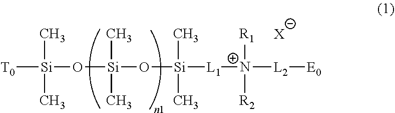
in which:
T₀ is a linear or branched C₁-C₆ alkyl which is optionally substituted with a hydroxyl or C₁-C₃ alkoxy group;
X^{⊖} is a counter anion;
R₁ and R₂ independent of each other are a C₁-C₄ alkyl
E₀ is a monovalent radical of 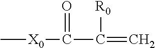
or 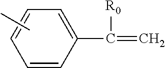
R₀ is hydrogen or methyl;
a₀ is zero or 1;
X₀ is O or NR_{N1};
R_{N1} is hydrogen or a C₁-C₆ alkyl;
n1 is an integer of from 4 to 50;
L₁ is a divalent radical of 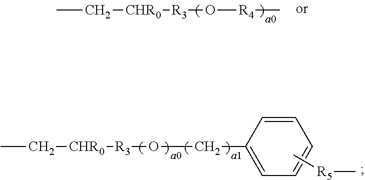
a₀ and a₁ independent of each other are zero or 1;
R₃ and R₅ independent of each other are a direct bond or a linear or branched C₁-C₃ alkylene divalent radical which is optionally substituted with C₁-C₄ alkoxy group or hydroxyl group;
R₄ is a linear or branched C₁-C₆ alkylene divalent radical which is optionally substituted with C₁-C₄ alkoxy group or hydroxyl group;
R₅ is a direct bond, a linear or branched C₁-C₃ alkylene divalent radical which is optionally substituted with C₁-C₄ alkoxy group or hydroxyl group, or a divalent radical of 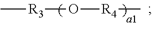
L₂ is either a linear or branched C₁-C₆ alkylene divalent radical which is optionally substituted with C₁-C₃ alkoxy or hydroxyl group or a divalent radical of

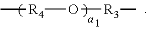

3. The polysiloxane vinylic monomer of claim 2, wherein in formula (1) n1 is from 4 to 40.

4. The polysiloxane vinylic monomer of claim 3, wherein in formula (1) E₀ is a monovalent radical of

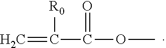

5. The polysiloxane vinylic monomer of claim 3, wherein in formula (1) E₀ is a monovalent radical of 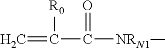
in which R_{N1} is hydrogen or a C₁-C₆ alkyl.

6. The polysiloxane vinylic monomer of claim 3, wherein in formula (1) E₀ is a monovalent radical of

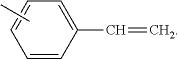

7. A silicone hydrogel contact lens, comprising a silicone hydrogel bulk material which comprises repeating units of a polysiloxane vinylic monomer of formula (1) 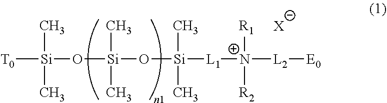
in which:
T₀ is a linear or branched C₁-C₆ alkyl which is optionally substituted with a hydroxyl or C₁-C₃ alkoxy group;
X^{⊖} is a counter anion;
R₁ and R₂ independent of each other are a C₁-C₄ alkyl
E₀ is a monovalent radical of 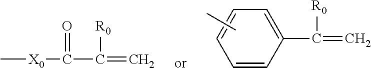
R₀ is hydrogen or methyl;
a₀ is zero or 1;
X₀ is O or NR_{N1};
R_{N1} is hydrogen or a C₁-C₆ alkyl;
n1 is an integer of from 4 to 50;
L₁ is a divalent radical of 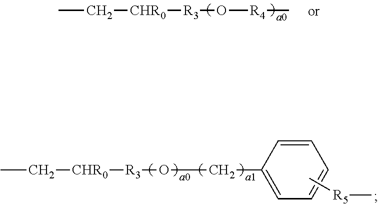
a₀ and a₁ independent of each other are zero or 1;
R₃ and R₅ independent of each other are a direct bond or a linear or branched C₁-C₃ alkylene divalent radical which is optionally substituted with C₁-C₄ alkoxy group or hydroxyl group;
R₄ is a linear or branched C₁-C₆ alkylene divalent radical which is optionally substituted with C₁-C₄ alkoxy group or hydroxyl group;
R₅ is a direct bond, a linear or branched C₁-C₃ alkylene divalent radical which is optionally substituted with C₁-C₄ alkoxy group or hydroxyl group, or a divalent radical of 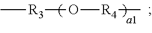
L₂ is either a linear or branched C₁-C₆ alkylene divalent radical which is optionally substituted with C₁-C₃ alkoxy or hydroxyl group or a divalent radical of

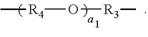

8. The silicone hydrogel contact lens of claim 7, wherein in formula (1) n1 is from 4 to 40.

9. The silicone hydrogel contact lens of claim 8, wherein in formula (1) E₀ is a monovalent radical of

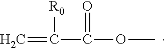

10. The silicone hydrogel contact lens of claim 8, wherein in formula (1) E₀ is a monovalent radical of 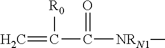
in which R_{N1} is hydrogen or a C₁-C₆ alkyl.

11. The silicone hydrogel contact lens of claim 8, wherein in formula (1) E₀ is a monovalent radical of

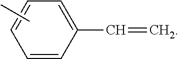

12. The silicone hydrogel contact lens of claim 8, wherein the silicone hydrogel contact lens, when being fully hydrated, has an oxygen permeability (Dk) of at least about 40 barrers, a water content of from about 15% to about 70% by weight, and an elastic modulus of from about 0.20 MPa to about 1.8 MPa.

13. The silicone hydrogel contact lens of claim 12, wherein the silicone hydrogel bulk material also comprises: repeating units of units of at least one vinylic crosslinker which comprises at least one polysiloxane vinylic crosslinker and/or at least one non-silicone vinylic crosslinker; and units of at least one hydrophilic vinylic monomer.

14. The silicone hydrogel contact lens of claim 13, wherein said at least one vinylic crosslinker comprises at least one polysiloxane vinylic crosslinker.

15. The silicone hydrogel contact lens of claim 14, wherein said at least one polysiloxane vinylic crosslinker comprises a di-(meth)acryloyl-terminated polydimethylsiloxane, a di-vinyl carbonate-terminated polydimethylsiloxane; a di-vinyl carbamate-terminated polydimethylsiloxane; N,N,N′,N′-tetrakis(3-methacryloxy-2-hydroxypropyl)-alpha,omega-bis-3-aminopropyl-polydimethylsiloxane, or a combination thereof.

16. The silicone hydrogel contact lens of claim 15, wherein said at least one polysiloxane vinylic crosslinker comprises a vinylic crosslinker of formula (1) 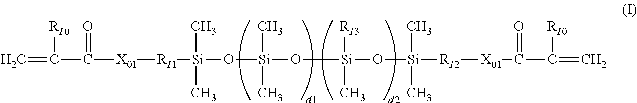
in which:
d1 is an integer of from 30 to 500 and d2 is an integer of from 1 to 75, provided that d2/d1 is from about 0.035 to about 0.15 (preferably from about 0.040 to about 0.12, even more preferably from about 0.045 to about 0.10);
X₀₁ is O or NR_{IN} in which R_{IN} is hydrogen or C₁-C₁₀-alkyl;
Rₗ₁ is hydrogen or methyl;
Rₗ₁ and Rₗ₂ independently of each other are a substituted or unsubstituted C₁-C₁₀ alkylene divalent radical or a divalent radical of —R₁₄—O—R₁₅— in which R₁₄ and R₁₅ independently of each other are a substituted or unsubstituted C₁-C₁₀ alkylene divalent radical;
Rₗ₃ is a monovalent radical of any one of formula (Ia) to (le) 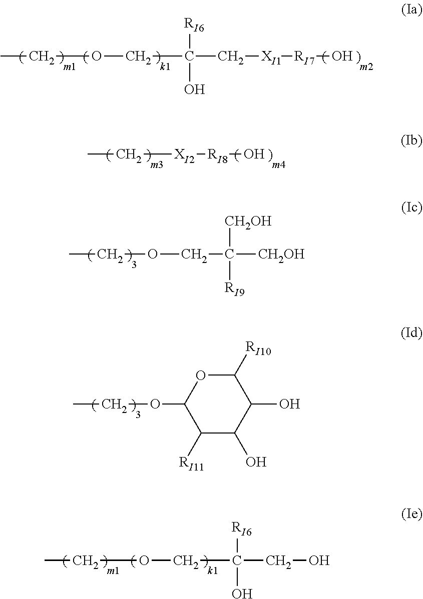
k1 is zero or 1; m1 is an integer of 2 to 4; m2 is an integer of 1 to 5; m3 is an integer of 3 to 6; m4 is an integer of 2 to 5;
Rₗ₆ is hydrogen or methyl;
Rₗ₇ is a C₂-C₆ hydrocarbon radical having (m2+1) valencies;
Rₗ₈ is a C₂-C₆ hydrocarbon radical having (m4+1) valencies;
Rₗ₉ is ethyl or hydroxymethyl;
Rₗ₁₀ is methyl or hydroxymethyl;
Rₗ₁₁ is hydroxyl or methoxy;
Xₗ₁ is a sulfur linkage of —S— or a teriary amino linkage of —NRₗ₁₂— in which Rₗ₁₂ is C₁-C₁ alkyl, hydroxyethyl, hydroxypropyl, or 2,3-dihydroxypropyl; and
X₁₂ is an amide linkage of 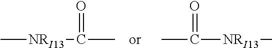
in which Rₗ₁₃ is hydrogen or C₁-C₁₀ alkyl.

17. The silicone hydrogel contact lens of 15, wherein said at least one polysiloxane vinylic crosslinker comprises: (1) a vinylic crosslinker which comprises one sole polydiorganosiloxane segment and two terminal ethylenically-unsaturated groups selected from the group consisting of (meth)acryloyloxy groups, (meth)acryloylamino groups, vinyl carbonate groups, vinylcarbamate groups; and/or (2) a chain-extended polysiloxane vinylic crosslinker which comprises at least two polydiorganosiloxane segment and a covalent linker between each pair of polydiorganosiloxane segments and two two terminal ethylenically-unsaturated groups selected from the group consisting of (meth)acryloyloxy groups, (meth)acryloylamino groups, vinyl carbonate groups, vinylcarbamate groups.

18. The silicone hydrogel contact lens of claim 15, wherein said at least one polysiloxane vinylic crosslinker comprises α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxypropyl]-terminated polydimethylsiloxane, α,ω-bis[3-(meth)acryloxybutyloxy-2-hydroxypropyloxypropyl]-terminated polydimethylsiloxane, α,ω-bis[3-(meth)acrylamidoethoxy-2-hydroxypropyloxypropyl]-terminated polydimethylsiloxane, α,ω-bis[3-(meth)acrylamidopropyloxy-2-hydroxypropyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethylamino-2-hydroxypropyloxypropyl]-terminated polydimethylsiloxane, α,ω-bis[3-(meth)acryloxypropylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, or combinations thereof.

19. The silicone hydrogel contact lens of claim 15, wherein the silicone hydrogel bulk material comprises: (a) repeating units of at least one hydrophilic vinylic monomer selected from the group consisting of N-vinylpyrrolidone, N-vinyl-N-methyl acetamide, N,N-dimethyl (meth)acrylamide, and combinations thereof; (b) repeating units of at least non-silicone vinylic crosslinker; (c) repeating units of at least one UV-absorbing vinylic monomer and/or at least one UV/HEVL-absorbing vinylic monomer; (d) combinations thereof.
